(19) United States
(12) Patent Application Publication
(10) Pub. No.: US 2020/0002872 A1
(43) Pub. Date: Jan. 2, 2020

(54) APPARATUS AND METHOD FOR CLOTHES TREATING

(71) Applicant: LG ELECTRONICS INC., Seoul (KR)

(72) Inventor: Tae Hwan KIM, Seoul (KR)

(73) Assignee: LG ELECTRONICS INC., Seoul (KR)

(21) Appl. No.: 16/568,141

(22) Filed: Sep. 11, 2019

(30) Foreign Application Priority Data
Jun. 13, 2019 (KR) 10-2019-0070094

(51) Int. Cl. D06F 39/00; D06F 35/00; D06F 58/28; G05B 15/02; G06K 19/077

(52) U.S. Cl. CPC D06F 39/003; D06F 35/005; D06F 58/28; G05B 15/02; D06F 2058/2861; D06F 2202/10; D06F 2232/10; D06F 2204/10; G06K 19/07758

(57) ABSTRACT

Provided herein is a clothing treatment apparatus and method therefor that allows an optimal treatment course to be performed depending on clothing being put into a clothing treatment appliance. The clothing treatment apparatus according to one aspect of the present disclosure includes: a clothing treatment appliance configured to perform at least one of washing, drying, sterilizing, deodorizing, dust removing, or wrinkle removing for the clothing, an identifying unit configured to individually identify clothing information on each piece of clothing being put into the clothing treatment appliance, an analyzing unit configured to deduce one optimal course based on each recommended course registered to be associated with the clothing information individually identified by the identifying unit, and a control unit configured to control an operation of the clothing treatment appliance according to the optimal course deduced by the analyzing unit.

### CROSS-REFERENCE TO RELATED APPLICATION

Pursuant to 35 U.S.C. §119(a), this application claims the benefit of earlier filing date and right of priority to Korean Application No. 10-2019-0070094, filed on Jun. 13, 2019, the contents of which are all hereby incorporated by reference herein in its entirety.

### BACKGROUND OF THE DISCLOSURE

### Field of the Disclosure

The present disclosure relates to a clothing treatment apparatus and method therefor that allow an optimal treatment course to be performed depending on the clothing being put into a clothing treatment appliance.

### Description of Related Art

Generally, a clothing treatment appliance refers to various appliances for clothing treatment, such as a washing machine, a dryer, or a styler that, for example, wash clothing, remove moisture, odor, or dust from the clothing, or remove wrinkles in the clothing to suit a preference of a user.

Meanwhile, the type of clothing varies depending on a usage and a material thereof, and accordingly, the manner of clothing treatment through the clothing treatment appliance needs to be performed differently depending on the type of the clothing. However, since a general clothing treatment appliance performs substantially only one treatment course even when various types of clothing are simultaneously put into therein, there is a limitation in the treatment that reflects the characteristics of all the clothing.

Particularly, it is troublesome for the user to set one treatment course by considering the characteristics of various types of clothing each time the user uses the clothing treatment appliance. When the user does not know the exact characteristics of all the clothing, the treatment course set by the user may be inappropriate.

Therefore, it is necessary to set an optimal course by automatically and collectively considering the characteristics of all the clothing when operating the clothing treatment appliance into which various types of clothing are put.

In relation to the clothing treatment appliance described above, Korean Patent Application Publication No. 10-2017-0138559, entitled “Washing Machine Control Method and Washing Machine” (hereinafter referred to as “Related Art 1”), discloses a washing machine and a method for controlling the washing machine.

Specifically, Related Art 1 discloses, for example, obtaining an image of a piece of laundry via a picture or video capturing method, confirming basic information on each piece of laundry through a comparison process, and automatically selecting a washing program according to the basic information on the laundry.

However, in the washing machine disclosed in Related Art 1, the washing program is selected based on only the basic information on the specific clothing photographed and not selected by considering the basic information on various types of clothing collectively.

In addition, Korean Patent Application Publication No. 10-2009-0076722, entitled “Apparatus and Method for Washing Clothes using RFID” (hereinafter referred to as “Related Art 2”), discloses a washing machine and a clothes washing manner using a radio frequency identification (RFID).

Specifically, Related Art 2 discloses, for example, receiving an RFID signal generated from an RFID tag attached to a piece of laundry, obtaining history information on the piece of laundry, and washing the piece of laundry according to the history information.

However, in the washing machine of Related Art 2, the washing is performed based on only the history information on the laundry classified depending on color, material, weight, date of manufacture, washing condition, or washing manner by using the RFID tag, and is not performed by considering the history information on various types of clothing collectively.

As described above, the clothing treatment appliance in the related art is unable to perform the optimal treatment course depending on the clothing being put into the clothing treatment appliance.

### SUMMARY OF THE DISCLOSURE

The present disclosure is directed to addressing the above-mentioned shortcomings of clothing treatment appliances in the related art.

Specifically, the present disclosure is directed to setting one optimal course for various types of clothing by collectively and automatically considering the characteristic of each of the various types of clothing in a state where the various types of clothing are simultaneously put into a clothing treatment appliance.

The present disclosure is further directed to minimizing the possibility of damage to each of the various types of clothing by performing a confirm procedure based primarily on delicate clothing when one treatment course for the various types of clothing is set in a state where the various types of clothing are simultaneously put into a clothing treatment appliance.

The present disclosure is still further directed to operating a plurality of clothing treatment appliances in association with each other in complementary fashion depending on the characteristic of the clothing when the plurality of clothing treatment appliances are used to treat the clothing.

The present disclosure is not limited to what has been disclosed hereinabove. A person skilled in the art may clearly understand, from the following description, other aspects not mentioned above.

A clothing treatment apparatus and method therefor according to one aspect of the present disclosure may be configured to cause clothing information on individually identified pieces of clothing to be considered collectively and automatically in an operation of a clothing treatment appliance. Specifically, the clothing treatment apparatus and method therefor may be configured such that after the clothing information on each piece of clothing being put into the clothing treatment appliance is individually identified, the clothing treatment appliance may operate according to one optimal course deduced based on each recommended course selected to be associated with the identified clothing information.

In addition, a clothing treatment apparatus and method therefor according to one aspect of the present disclosure may be configured to perform a confirm procedure by a user before operating a clothing treatment appliance according to a deduced optimal course. Specifically, the clothing treatment apparatus and method therefor may be configured to inform a user of the presence of delicate clothing for the deduced optimal course among the clothing being put into the clothing treatment appliance, and to be confirmed from the user whether to proceed with the optimal course.

In addition, a clothing treatment apparatus and method therefor according to one aspect of the present disclosure may be configured to cause the clothing to be put into a clothing treatment appliance capable of treating the clothing among a plurality of clothing treatment appliances. Specifically, the clothing treatment apparatus and method therefor may be configured such that, when one clothing treatment appliance is unable to treat clothing due to the presence of delicate clothing, the delicate clothing may be guided to be put into another clothing treatment appliance capable of treating the delicate clothing.

In addition, a clothing treatment apparatus and method therefor according to one aspect of the present disclosure may be configured to cause a home server to receive identified clothing information, deduce an optimal course, and transmit a control signal for the optimal course to a clothing treatment appliance.

In addition, a clothing treatment apparatus and method therefor according to one aspect of the present disclosure may be configured to previously register clothing information on each piece of clothing and a recommended course according to the clothing information.

In addition, an clothing treatment apparatus and method therefor according to one aspect of the present disclosure may be configured to obtain an image of a label and fabric construction for each piece of clothing, and to register the image as clothing information.

In addition, a clothing treatment apparatus and method therefor according to one aspect of the present disclosure may be configured to convert the obtained image into a code, to attach the code to the clothing, and to identify the code via an identifying unit.

In addition, a clothing treatment apparatus and method therefor according to one aspect of the present disclosure may be configured to convert the obtained image into a radio frequency identification (RFID) tag, to attach the RFID tag to the clothing, and to identify the RFID tag via an identifying unit.

In addition, a clothing treatment apparatus and method therefor according to one aspect of the present disclosure is configured to utilize previously registered clothing information when registering clothing information on each piece of clothing.

The present disclosure is not limited to what has been disclosed hereinabove. A person skilled in the art may clearly understand, from the following description, other aspects not mentioned above.

According to various embodiments of the present disclosure, the following effects can be provided.

According to at least one of the embodiments of the present disclosure, after clothing information on each piece of clothing being put into a clothing treatment appliance is individually identified, the clothing treatment appliance may operate according to one optimal course deduced based on each recommended course selected to be associated with the identified clothing information, thereby setting an optimal course by collectively and automatically considering the characteristic of each piece of clothing.

In addition, according to at least one of the embodiments of the present disclosure, when a delicate clothing for a deduced optimal course is present among clothing being put into a clothing treatment appliance, this fact may be informed to a user and whether to proceed with the optimal course may be confirmed by the user, thereby minimizing the possibility of damage to the clothing by identifying delicate clothing separately.

In addition, according to at least one of the embodiments of the present disclosure, when one clothing treatment appliance is unable to treat the clothing due to the presence of delicate clothing, the delicate clothing may be guided to be put into another clothing treatment appliance capable of treating the delicate clothing, thereby operating a plurality of clothing treatment appliances in association with each other in complementary fashion.

In addition, according to at least one of the embodiments of the present disclosure, a home server may receive identified clothing information, deduce an optimal course, and transmit a control signal for the optimal course to a clothing treatment appliance, thereby allowing each clothing treatment appliance to operate in association with various devices via a home network by the home server, and relatively simplifying the structures of the clothing treatment appliances.

In addition, according to at least one of the embodiments of the present disclosure, clothing information on each piece of clothing and a recommended course according to the clothing information may be previously registered, thereby continuously and integrally treating each piece of clothing via only one registration procedure for each piece of clothing.

In addition, according to at least one of the embodiments of the present disclosure, an image of a label and fabric construction for each piece of clothing may be obtained and registered as clothing information, thereby making it easier for a user to register the clothing information.

In addition, according to at least one of the embodiments of the present disclosure, the obtained image may be converted into a code, the code may be attached to clothing, and an identifying unit may identify the code attached to the clothing, thereby making it easier for the clothing to be identified even when the label of the clothing is damaged due to clothing becoming worn.

In addition, according to at least one of the embodiments of the present disclosure, the obtained image may be converted into an RFID tag, the RFID tag may be attached to clothing, and the identifying unit may identify the RFID tag attached to the clothing, thereby making it easier for a user to perform an identification procedure.

In addition, according to at least one of the embodiments of the present disclosure, when registering clothing information on each piece of clothing, previously registered clothing information may be utilized, thereby simplifying a registration procedure for similar clothing.

Further scope of applicability of the present disclosure will become apparent from the detailed description given hereinafter. However, it would be obvious to those skilled in the art that various changes and modifications can be made without departing from the spirit and scope of the present disclosure. Thus, it is to be understood that the detailed description and the embodiments of the present disclosure are merely exemplary.

### BRIEF DESCRIPTION OF THE DRAWINGS

The foregoing and other objects, features, and advantages of the present disclosure, as well as the following detailed description of the embodiments, will be better understood when read in conjunction with the accompanying drawings. For the purpose of illustrating the present disclosure, there is shown in the drawings an exemplary embodiment that is presently preferred, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is a perspective view exemplarily showing a clothing treatment apparatus according to one embodiment of the present disclosure.

FIG. 2 is a view schematically showing a main configuration of a clothing treatment apparatus according to one embodiment of the present disclosure.

FIG. 3 is a view exemplarily showing an operation guiding unit in a clothing treatment apparatus according to one embodiment of the present disclosure.

FIG. 4 is a view showing an example of a registering unit and an identifying unit in a clothing treatment apparatus according to one embodiment of the present disclosure.

FIG. 5 is a view showing another example of a registering unit and an identifying unit in a clothing treatment apparatus according to one embodiment of the present disclosure.

FIG. 6 is a flowchart showing a clothing treatment method according to one embodiment of the present disclosure.

FIG. 7 is a view exemplarily showing steps for registering clothing information and a recommended course in a clothing treatment method according to one embodiment of the present disclosure.

### DETAILED DESCRIPTION

Hereinafter, the embodiments disclosed in this specification will be described in detail with reference to the accompanying drawings. The detailed description of related known technology will be omitted when it may obscure the subject matter of the embodiments according to the present disclosure.

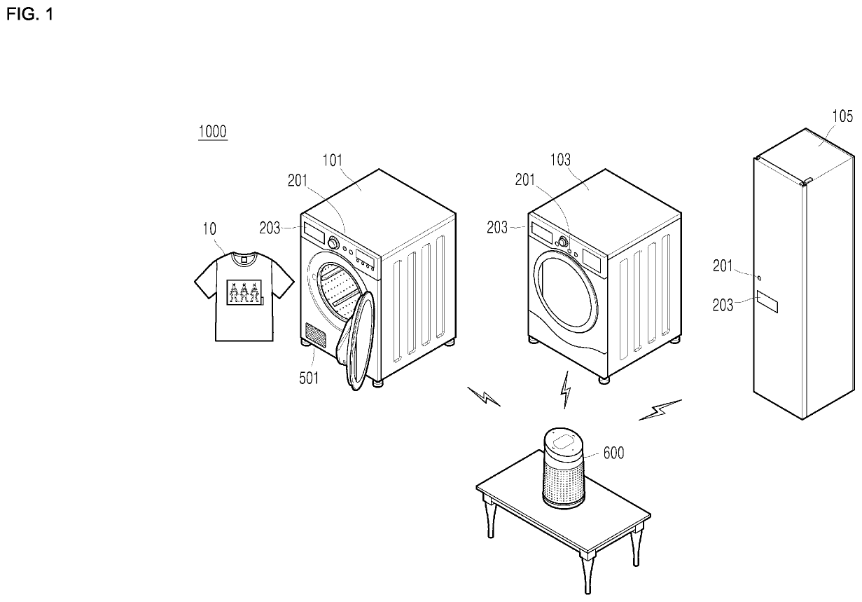

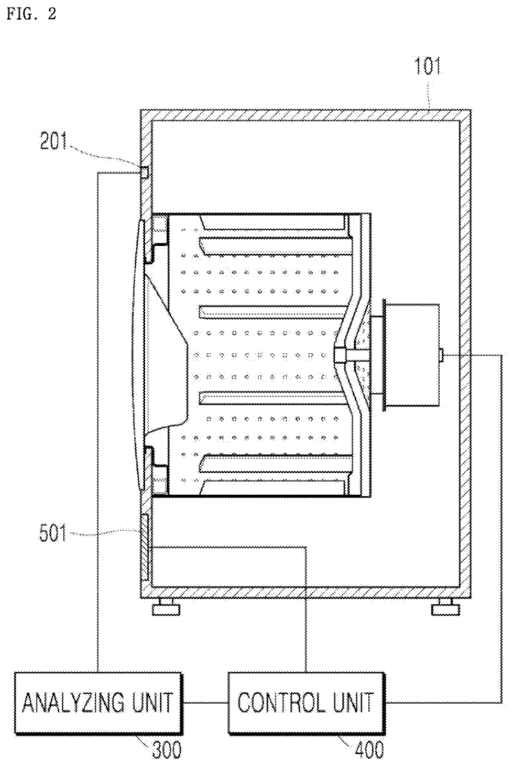

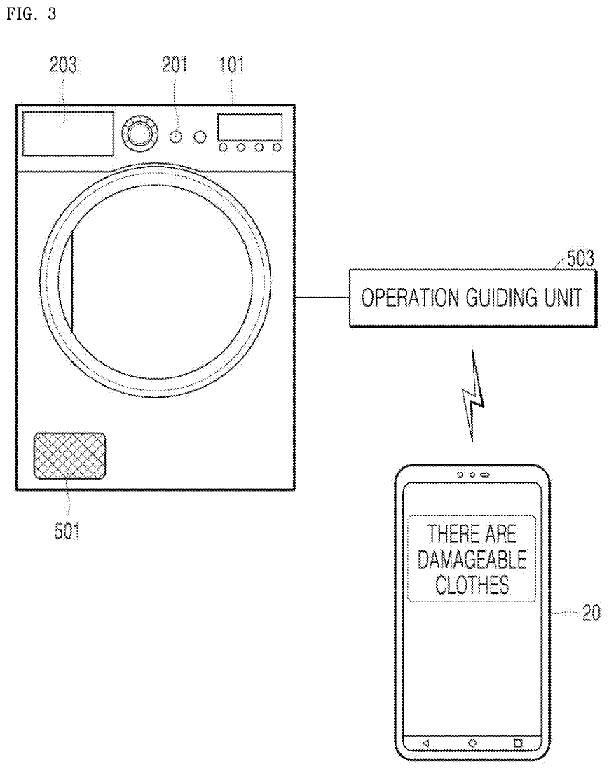

FIG. 1 is a perspective view exemplarily showing a clothing treatment apparatus according to one embodiment of the present disclosure. FIG. 2 is a view schematically showing a main configuration of the clothing treatment apparatus according to one embodiment of the present disclosure. FIG. 3 is a view exemplarily showing an operation guiding unit in the clothing treatment apparatus according to one embodiment of the present disclosure.

As shown FIGS. 1 to 3, the clothing treatment apparatus 1000 according to one embodiment of the present disclosure includes clothing treatment appliances 101, 103, 105, identifying units 201, 203, an analyzing unit 300, and a control unit 400.

The clothing treatment appliances 101, 103, 105 are for performing at least one of washing, drying, sterilizing, deodorizing, dust removing, or wrinkle removing for clothing 10, and may be at least one of a washing machine, a dryer, or a styler, capable of treating the clothing 10 to suit the preference of a user.

As used herein, the clothing 10 may include garments, hats, shoes, and the like worn by the user, but is not limited thereto. That is, the clothing 10 may also include objects, such as curtains, bedclothes, and various covers, that are not worn by the user but are made of fabric and thus are subject to at least one of washing, drying, sterilizing, deodorizing, dust removing, or wrinkle removing.

The identifying units 201, 203 are for individually identifying clothing information on each piece of clothing 10 being put into the clothing treatment appliance 101, 103, 105, and may determine the characteristic of each piece of clothing 10 in the process of being put into the clothing treatment appliance 101, 103, 105.

As used herein, examples of the clothing information may include color, material, weight, date of manufacture, washing condition, and washing manner for the corresponding clothing 10, and may also include, for example, the number of cumulative treatments for the clothing 10 having a past treatment history.

The analyzing unit 300 is for deducing one optimal course based on each recommended course selected to be associated with the clothing information individually identified by the identifying units 201, 203, and may deduce the most appropriate operating course by collectively analyzing all the clothing 10 being put into the clothing treatment appliances 101, 103, 105.

As used herein, the recommended course refers to the operating course associated with the clothing information on each piece of clothing 10, and may be a treatment course for the corresponding clothing 10 recommended by the manufacturer of the clothing 10 by considering the characteristic of each piece of clothing 10, or a treatment course that the user has registered separately for his/her preference for corresponding clothing 10.

Accordingly, one recommended course may be selected to be associated with a single piece of clothing 10, and the recommended courses for each piece of clothing 10 may be selected by identifying the clothing information via the identifying units 201, 203.

However, when the clothing 10 having different characteristics and thus different recommended courses are simultaneously put into one clothing treatment appliance 101, 103, 105, the clothing treatment appliance 101, 103, 105 is not capable of operating according to all the recommended courses for all the clothing 10.

As used herein, the analyzing unit 300 may deduce one optimal course based on the result of collectively analyzing the recommended course for each piece of clothing 10.

To this end, the analyzing unit 300 may include or be connected to a database server that provides big data and fusion sensing data needed to apply various artificial intelligence algorithms.

As a result, the analyzing unit 300 may deduce one optimal course that is most appropriate for all the clothing 10 in the clothing treatment appliance 101, 103, 105 by collectively considering the recommended course for each piece of clothing 10 via sensor fusion or deep learning of the artificial intelligence algorithm.

The control unit 400 is for controlling the operation of the clothing treatment appliance 101, 103, 105 according to the optimal course deduced by the analyzing unit 300, and may control, for example, order, time, and intensity of operation of the clothing treatment appliance 101, 103, 105 according to the optimal course.

For example, the control unit 400 may automatically control a water level, a water temperature, an amount of detergent, a washing time, the number of rinsing, and a dehydration time in a washing machine, based on the optimal course.

As described above, in the clothing treatment apparatus 1000 according to the present embodiment, after the clothing information on each piece of clothing 10 being put into clothing treatment appliance 101, 103, 105 is individually identified, the clothing treatment appliance 101, 103, 105 operates according to a deduced optimal course based on each recommended course selected to be associated with the identified clothing information, thereby setting the optimal course by automatically and collectively considering the characteristic of each piece of clothing 10.

The clothing treatment apparatus 1000 according to the present embodiment may further include an operation guiding units 501, 503 configured to output guidance information when the delicate clothing for the deduced optimal course is present among the clothing 10 being put into the clothing treatment appliance 101, 103, 105.

In the case of deducing one optimal course via the process as described above, this optimal course is deduced by collectively considering the characteristics of all the pieces of clothing 10 in the clothing treatment appliance 101, 103, 105.

However, a particular piece of clothing 10 may still incur damage due to this optimal course. For example, when it is deduced that most of the clothing 10 in the clothing treatment appliance 101, 103, 105 need to be treated at a high temperature for a long time, a wool product and the like, sensitive to such a treatment environment, that is in the clothing treatment appliance 101, 103, 105 may incur damage, such as a reduction in size during treatment.

Therefore, in such a case, after informing a user of the possibility of damage to the particular piece of clothing 10 due to the deduced optimal course and receiving feedback from the user, there is a need to operate the clothing treatment appliance 101, 103, 105.

To this end, the operation guide unit 501 may include, for example, a speaker capable of outputting a voice signal and a display capable of displaying a visual signal so as to inform the user of the presence of the delicate clothing.

Alternatively, as shown in FIG. 3, the operation guiding unit 503 may be configured to transmit guidance information on the presence of the delicate clothing to a user terminal 20, and to receive feedback about the guidance information from the user regardless of the location of the user.

As used herein, the control unit 400 may control the operation of the clothing treatment appliance 101, 103, 105 by changing the optimal course, for example, adjusting a treatment intensity to low or minimizing treatment time, according to a result of the user's feedback about the guidance information transmitted from the operation guiding units 501, 503.

As described above, in the clothing treatment apparatus 1000 according to the present embodiment, when the delicate clothing for the deduced optimal course is present among the clothing 10 being put into the clothing treatment appliance 101, 103, 105, this fact may be informed to the user and whether to proceed with the optimal course may be confirmed by the user, thereby minimizing the possibility of damage to the clothing 10 by identifying the delicate clothing separately.

In the clothing treatment apparatus 1000 according to the present embodiment, a plurality of clothing treatment appliances 101, 103, 105 may be installed to treat the clothing 10 in association with each other. The analyzing unit 300 may be configured to deduce the optimal course for the clothing 10 each time the clothing 10 is put into each clothing treatment appliance 101, 103, 105. The operation guiding units 501, 503 may be configured such that when there is no user agreement on the operation after the guidance information is outputted by one clothing treatment appliance 101, 103, 105, the delicate clothing may be guided to be put into another clothing treatment appliance 101, 103, 105 capable of treating the delicate clothing.

As described above, as a result of informing the user of the presence of the delicate clothing, when the user still agrees to the operation according to the corresponding optimal course, the clothing treatment appliance 101, 103, 105 may operate according to the deduced optimal course, without any additional adjustment.

On the contrary, there may be no feedback for a predetermined period of time because, for example, the user does not agree to the operation according to the corresponding optimal course or because the user does not recognize the guidance information.

As used herein, the clothing 10 may be guided to be put into the other clothing treatment appliance 101, 103, 105, without immediately switching the corresponding clothing treatment appliance 101, 103, 105 to standby mode. This guiding process may be performed by providing the user with separate information on the clothing treatment appliance 101, 103, 105 which is capable of treating the clothing 10 most appropriately at present.

Alternatively, when separate transfer devices are provided between the clothing treatment appliances 101, 103, 105, this guiding process may be performed by transferring the clothing 10 from the corresponding clothing treatment appliance 101, 103, 105 to the clothing treatment appliance 101, 103, 105 capable of treating the clothing 10 most appropriately.

As described above, in the clothing treatment apparatus 1000 according to the present embodiment, when one clothing treatment appliance 101, 103, 105 is unable to treat the clothing due to the presence of the delicate clothing, the delicate clothing may be guided to be put into another clothing treatment appliance 101, 103, 105 capable of treating the delicate clothing, thereby allowing the plurality of clothing treatment appliances 101, 103, 105 to operate in association with each other in complementary fashion.

The clothing treatment apparatus 1000 according to the present embodiment may further include a home server 600 configured to communicate with the clothing treatment appliance 101, 103, 105 disposed in an established network area. The home server 600 may perform data transmission/reception and control functions for devices that are installed in the network area specified by the user and are communicably connected.

For example, the home server 600 may be configured to function as a hub device of an Internet of Things (IoT) for home use and may be configured to exchange data with the devices or control the devices disposed in the network area with a certain range from the home server 600.

In addition, the home server 600 may be a separate individual device, or may be installed in another device, such as a refrigerator or a TV, in a home.

As used herein, the network used between the home server 600 and the clothing treatment appliance 101, 103, 105 may be a wired or wireless network such as a local area network (LAN), a wide area network (WAN), the Internet, an intranet, and an extranet. The network may also be a mobile network such as a cellular, 3G, 4G, LTE, 5G, or WiFi network, an ad hoc network, and any suitable communication network including combinations thereof.

Particularly, when the 5G network is used, the artificial intelligence algorithm may be smoothly applied with the characteristics of ultra-low latency and hyperconnectivity, and the Internet of Things (IoT) technology capable of operating in association with devices other than the clothing treatment appliance 101, 103, 105 may be smoothly implemented.

As used herein, the network may include connections between network elements, such as a hub, a bridge, a router, a switch, and a gateway. The network may include one or more connected networks, such as a multi-network environment including a public network such as the Internet and a private network such as a secure enterprise private network. Access to the network may be provided via one or more wired or wireless access networks.

When the clothing treatment apparatus 1000 includes the home server 600, the identifying units 201, 203 may transmit the identified clothing information to the home server 600. The analyzing unit 300 and the control unit 400 are installed in the home server 600 and may transmit the control signal for the deduced optimal course to each clothing treatment appliance 101, 103, 105.

That is, after receiving the clothing information on each piece of clothing 10 being put into one clothing treatment appliance 101, 103, 105, the home server 600 deduces the optimal course, and generates the control signal for the optimal course. In addition, the home server 600 may transmit the generated control signal to the clothing treatment appliance 101, 103, 105 to control the operation thereof.

As described above, in the clothing treatment apparatus 1000 according to the present embodiment, the home server 600 may receive the identified clothing information, deduce the optimal course, and transmit the control signal for the optimal course to the clothing treatment appliance 101, 103, 105, thereby allowing each clothing treatment appliance 101, 103, 105 to operate in association with various devices on a home network via the home server 600, and relatively simplifying the structures of the clothing treatment appliances 101, 103, 105.

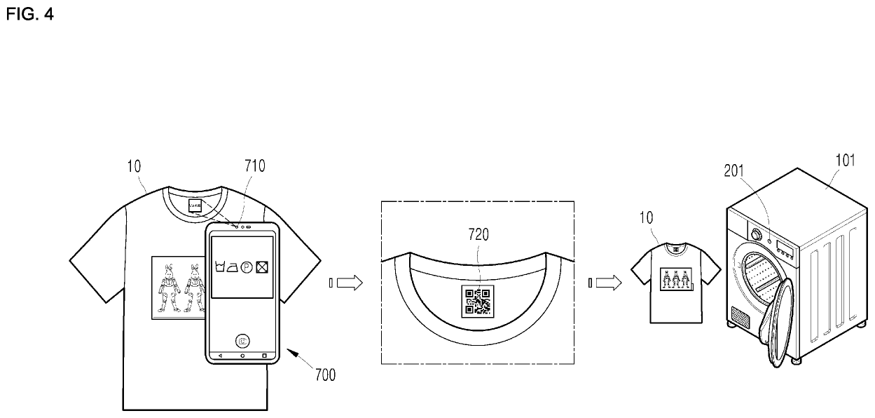

FIG. 4 is a view showing an example of a registering unit and an identifying unit in a clothing treatment apparatus according to one embodiment of the present disclosure.

As shown FIG. 4, the clothing treatment apparatus 1000 according to one embodiment of the present disclosure may further include a registering unit 700 configured to register each piece of clothing information and each recommended course according to each piece of clothing information.

Specifically, a user may perform a registration procedure for each piece of clothing 10 before putting the piece of clothing 10 into a clothing treatment appliance 101, 103, 105. The registration procedure may be performed by one clothing treatment appliance 101, 103, 105, or may be performed by a separate user terminal 20.

For example, when purchasing new clothing 10, the user may register the corresponding clothing 10 at the user terminal 20 or the clothing treatment appliance 101, 103, 105. In such a case, even if the user registers only the clothing information on the corresponding clothing 10, the recommended course for the corresponding clothing 10 may automatically become registered.

Alternatively, the user may directly register the recommended course for the corresponding clothing 10 in addition to the clothing information on the corresponding clothing 10.

The clothing 10 that was previously registered in the manner described above may be identified by the identifying units 201, 203 in the process of being put into the clothing treatment appliance 101, 103, 105. The clothing treatment appliance 101, 103, 105 may be operated to reflect the identified result.

As described above, in the clothing treatment apparatus 1000 according to the present embodiment, the clothing information on each piece of clothing 10 and the recommended course according to the clothing information may be previously registered, thereby continuously and integrally treating each piece of clothing 10 using only one registration procedure for each piece of clothing 10.

Here, the registering unit 700 may include a camera sensor 710 configured to obtain an image of a label and fabric construction for the clothing 10.

Specifically, the user may photograph the label and the fabric construction of the clothing 10 using the user terminal 20 or the clothing treatment appliance 101, 103, 105 including the camera sensor 710. The photographed image of the label and fabric construction may then be converted into data by using, for example, an optical character reader (OCR) or artificial intelligence image recognition technology, and may be registered via the registering unit 700.

As described above, in the clothing treatment apparatus 1000 according to the present embodiment, the image of the label and fabric construction for each piece of clothing 10 may be obtained and registered as clothing information, thereby making it easier for the user to register the clothing information.

Alternatively, in the clothing treatment appartus 1000 according to the present embodiment, the obtained image may be converted into a code 720. The code 720 may be attached to the clothing 10, thereby allowing the identifying unit 201 to identify the clothing information by identifying the code 720 attached to the clothing 10.

Specifically, as shown in FIG. 4, the user may obtain the image of the label and fabric construction by using the camera sensor 710. The obtained image may then be converted into the code 720 and attached to the clothing 10. The code 720 may be a code such as a numeric code, a bar code, and a QR code. The clothing 10 to which the code 720 is attached may then be identified by the identifying unit 201 in the process of being put into the clothing treatment appliance 101, 103, 105.

As used herein, the code 720 may be printed using a dedicated printing machine, a dedicated sticker paper available for a printer for home use, or an online printing service.

In particular, damage to the code 720 can be prevented during treatment of the corresponding clothing 10 by printing the code 720 of the corresponding clothing 10 on waterproof paper.

As described above, the clothing treatment apparatus 1000 according to the present embodiment is configured to convert the obtained image into a code and the code may be attached to the clothing 10. The identifying unit 201 may identify the code attached to the clothing 10, thereby making it easier for the clothing 10 to be identified even when the label of the clothing 10 is damaged due to wear and tear of the clothing 10.

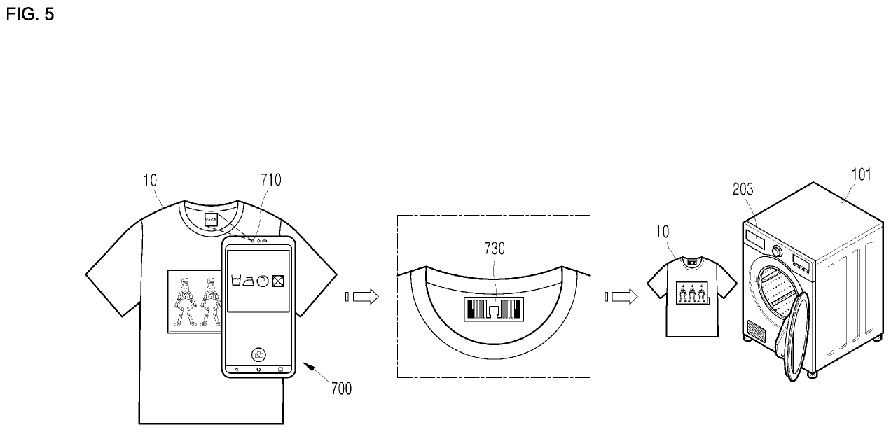

FIG. 5 is a view showing another example of a registering unit and an identifying unit in a clothing treatment apparatus according to one embodiment of the present disclosure.

As shown in FIG. 5, in a clothing treatment apparatus 1000 according to the present embodiment, an obtained image may be converted into an RFID tag 730, and the RFID tag 730 may be attached to a piece of clothing 10, thereby allowing an identifying unit 203 to identify clothing information by identifying the RFID tag 730 attached to the clothing 10.

Specifically, a user may obtain an image of a label and fabric construction by using a camera sensor 710. The obtained image may then be converted into the RFID tag 730, and the RFID tag 730 may be attached to the clothing 10. The clothing 10 to which the RFID tag 730 is attached may then be identified by the identifying unit 203 in the process of being put into a clothing treatment appliance 101, 103, 105.

As used herein, the RFID tag 730 may be generated by using an RFID writer or using an online generation service. The identifying unit 203 may include an RFID reader 203 capable of reading the RFID, so that the clothing 10 may be identified in the process of being put into the clothing treatment appliance without the need for a specific portion of the clothing 10 to face the identifying unit 203.

As described above, the clothing treatment apparatus 1000 according to the present embodiment is configured to convert the obtained image into an RFID tag and the RFID tag may be attached to the clothing 10. The identifying unit 201 may identify the RFID attached to the clothing 10, thereby making it easier for the user to perform an identification procedure.

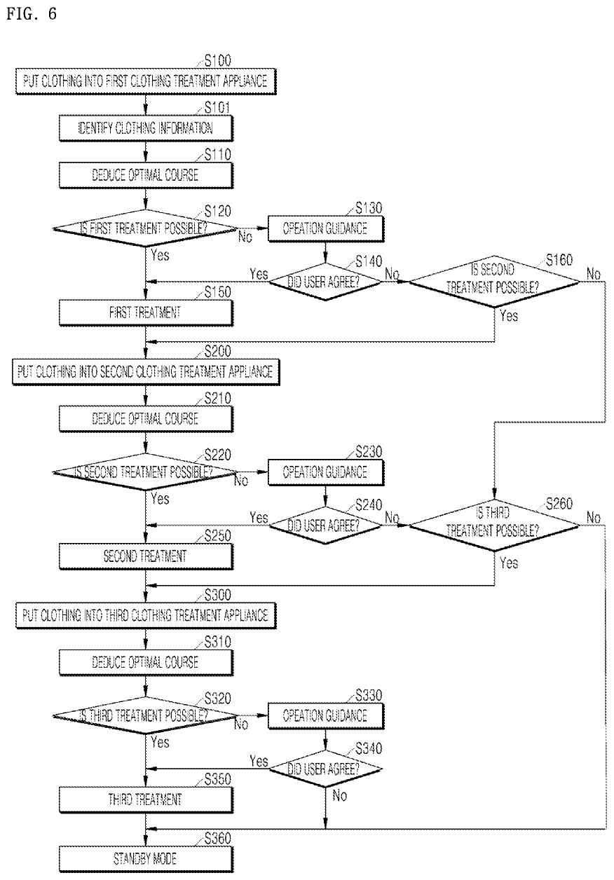

FIG. 6 is a flowchart showing a clothing treatment method according to one embodiment of the present disclosure.

Referring to FIG. 6, the clothing treatment method according to one embodiment of the present disclosure will be described below. As used herein, since the clothing treatment method according to the present embodiment may take place through the abovementioned main configuration of the clothing treatment apparatus 1000, the clothing treatment method will be described with reference to FIGS. 1 to 5.

First, the clothing 10 is put into a first clothing treatment appliance 101 (S100). The clothing information on each piece of clothing 10 is then individually identified in the process of being put into the clothing treatment appliance (S101). As used herein, the first clothing treatment appliance 101 refers to one of the abovementioned clothing treatment appliances 101, 103, 105 that treats the corresponding clothing 10 first.

Second, one optimal course is deduced based on each recommended course selected to be associated with the individually identified clothing information (S110). That is, all the clothing 10 being put into the first clothing treatment appliance 101 are collectively analyzed so that the most appropriate operating course may be deduced.

Third, it is determined whether to operate the first clothing treatment appliance 101 according to the deduced optimal course (S120). That is, it is determined whether there is delicate clothing that may be damaged when the first clothing treatment appliance 101 is operated according to the deduced optimal course.

When it is determined that no delicate clothing is present, a first clothing treatment 10 is performed by operating the first clothing treatment appliance 101 according to the optimal course (S150). Subsequently, the clothing 10 is put into a second clothing treatment appliance 103 for subsequent treatment of the clothing 10 (S200).

On the contrary, when it is determined that delicate clothing is present as a result of step S120, an operation guidance related to the delicate clothing is provided to the user (S130). That is, when the delicate clothing is present among the clothing 10 being put into the first clothing treatment appliance 101, the first clothing treatment appliance 101 outputs guidance information.

Next, as a result of the operation guidance, when the user still agrees to the operation according to the corresponding optimal course, the first clothing treatment appliance 101 may operate, without any additional adjustment, according to the deduced optimal course.

On the contrary, as a result of the operation guidance, when there is no feedback for a predetermined period of time because, for example, the user does not agree to the operation according to the corresponding optimal course or because the user does not recognize the guidance information, it is determined whether another clothing treatment appliance 103, 105 is capable of treating the delicate clothing (S160).

That is, when there is no user agreement on the operation after the guidance information is outputted by the first clothing treatment appliance 101, the delicate clothing is guided to be put into a second clothing treatment appliance 103 capable of treating the delicate clothing.

As used herein, when it is determined that the second clothing treatment appliance 103 is also unable to properly treat the corresponding clothing 10, it is then determined whether the other clothing treatment appliance 105 is capable of treating the corresponding clothing 10 (S260).

On the contrary, when it is determined that the second clothing treatment appliance 103 is capable of treating the corresponding clothing 10 as a result of step S160, the clothing 10 is guided to be put into the second clothing treatment appliance 103. Accordingly, when the clothing 10 is put into the second clothing treatment appliance 103, one optimal course may be deduced again based on each recommended course selected to be associated with the clothing information (S210).

That is, even when it is determined in step S160 that the second clothing treatment appliance 103 is capable of treating the delicate clothing, since the clothing 10 being actually put into the second clothing treatment appliance 103 may vary in an example of when some pieces of clothing 10 are missed or added, the optimal course for the clothing 10 being put into the second clothing treatment appliance 103 is deduced again.

Next, it is determined whether to operate the second clothing treatment appliance 103 according to the deduced optimal course (S220). When it is determined that there is no delicate clothing, the second clothing treatment appliance 103 may perform a second treatment for the clothing 10 (S250). That is, the operation of the second clothing treatment appliance 103 may be controlled according to the deduced optimal course.

However, when it is determined that there is delicate clothing as a result of step 5220, the operation guide is performed (S230), and when there is a user agreement after the operation guide was performed, the second treatment for the clothing 10 is also performed (S250). On the contrary, when there is no user agreement, it is determined whether the other clothing treatment appliance 105 is capable of treating the delicate clothing (S260).

Next, since each of the steps S300, S310, S320, S330, S340, and S350 in the third clothing treatment appliance 105 is substantially the same as or similar to each of the steps in the second clothing treatment appliance 103 described above, the detailed description of the overlapping contents will be omitted.

In addition, when the overall treatment for the clothing 10 is completed or when no clothing treatment appliance 101, 103, 105 may treat the delicate clothing, the clothing treatment appliances 101, 103, 105 may switch to a standby mode (S360).

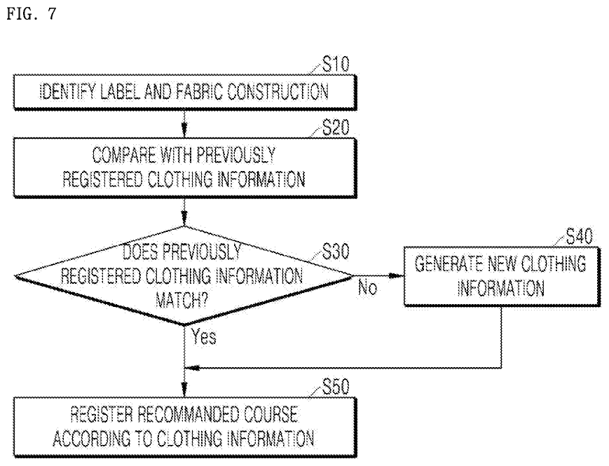

FIG. 7 is a view exemplarily showing steps for registering clothing information and a recommended course in a clothing treatment method according to one embodiment of the present disclosure.

As shown FIG. 7, the clothing treatment method according to one embodiment of the present disclosure may further include registering each piece of clothing information and each recommended course according to each piece of clothing information.

That is, clothing 10 that was registered may be identified by identifying units 201, 203 in the process of being put into clothing treatment appliance 101, 103, 105, and the clothing treatment appliance 101, 103, 105 may operate to reflect the identified result.

As used herein, registering the clothing information and the recommended information may include obtaining an image of a label and fabric construction for the clothing 10 (S10), comparing the obtained image with previously registered clothing information (S20), and generating new clothing information when the image does not match the previously registered clothing information (S40).

That is, in the process of previously registering the clothing 10, it is determined whether the clothing information on the clothing 10 matches the previously registered clothing information (S30). When the clothing information on the clothing 10 matches the previously registered clothing information, the previously registered clothing information may be selected as is, without any additional procedure.

On the contrary, a new registration procedure may proceed only when the clothing information on the clothing 10 does not match the previously registered clothing information.

Next, as described above, the recommended courses for the previously registered clothing information and each piece of newly generated clothing information may be registered (S50).

As described above, in clothing treatment method according to the present embodiment, the previously registered clothing information may be utilized when registering the clothing information on each piece of clothing 10, thereby simplifying the registration procedure for similar clothing 10.

Meanwhile, since the main configurations described in the clothing treatment method according to one embodiment of the present disclosure are the same as or similar to the main configurations in the clothing treatment apparatus 1000 described above according to one embodiment of the present disclosure, the detailed description of the overlapping contents will be omitted.

While the present disclosure has been explained in relation to its preferred embodiments, it is to be understood that various modifications thereof will become apparent to those skilled in the art upon reading the specification. Therefore, it is to be understood that the disclosure disclosed herein is intended to cover such modifications as fall within the scope of the appended claims.

### DESCRIPTION OF SYMBOLS

10: clothing

20: user terminal

101, 103, 105: clothing treatment appliance

201, 203: identifying unit

300: analyzing unit

400: control unit

501, 503: operation guiding unit

600: home server

700: registering unit

710: camera sensor

720: code

730: RFID tag

1000: clothing treatment apparatus

What is claimed is:

1. A clothing treatment apparatus, comprising:
a clothing treatment appliance configured to perform at least one of washing, drying, sterilizing, deodorizing, dust removing, or wrinkle removing for clothing;
an identifying unit configured to identify clothing information for each piece of the clothing located in the clothing treatment appliance;
an analyzing unit configured to identify a course based on each recommended course selected to be associated with the clothing information identified by the identifying unit; and
a control unit configured to control operation of the clothing treatment appliance according to the course identified by the analyzing unit.

2. The clothing treatment apparatus according to claim 1, further comprising:
an operation guiding unit configured to output guidance information when the identified clothing information identifies delicate clothing as being among the clothing located in the clothing treatment appliance.

3. The clothing treatment apparatus according to claim 2, further comprising:
a plurality of clothing treatment appliances, each appliance capable of treating the clothing in association with one or more other appliances of the plurality of clothing treatment appliances;
wherein the analyzing unit is further configured to identify a course each time the clothing is put into a respective one of the plurality of clothing treatment appliances, and
wherein the operation guiding unit is further configured to provide guidance for the delicate clothing to be placed into the second clothing treatment appliance from among the plurality of clothing treatments appliances, when there is no user agreement on operation after the guidance information is outputted by one of the clothing treatment appliances, wherein the second clothing treatment appliance is capable of treating the delicate clothing.

4. The clothing treatment apparatus according to claim 3, further comprising:
a server configured to communicate with the clothing treatment appliance disposed within an established network area,
wherein the identifying unit is configured to transmit the identified clothing information to the server, and
wherein the analyzing unit and the control unit are included in the server to transmit a control signal for the identified course to each of the clothing treatment appliances.

5. The clothing treatment apparatus according to claim 1, further comprising:
a registering unit configured to register the clothing information and each recommended course according to the clothing information.

6. The clothing treatment apparatus according to claim 5, wherein the registering unit comprises a camera configured to obtain an image of a label and fabric construction for the clothing.

7. The clothing treatment apparatus according to claim 6, wherein the obtained image is converted into a code for attaching to an associated item of the clothing, and
wherein the identifying unit is further configured to identify the clothing information by identifying the code attached to the clothing.

8. The clothing treatment apparatus according to claim 6,
wherein the obtained image is converted into a radio frequency identification (RFID) tag, and the RFID tag is attachable to the clothing, and
wherein the identifying unit is configured to identify the clothing information by identifying the RFID tag attached to the clothing.

9. The clothing treatment apparatus according to claim 1, wherein the course is an optimal course.

10. A clothing treatment method, comprising:
identifying clothing information for each piece of clothing located in a clothing treatment appliance;
identifying a course based on each recommended course selected to be associated with the identified clothing information; and
controlling operation of the clothing treatment appliance according to the identified course.

11. The clothing treatment method according to claim 10, further comprising:
outputting guidance information when the identified clothing information identifies delicate clothing as being among the clothing located in the clothing treatment appliance.

12. The clothing treatment method according to claim 11, further comprising:
outputting further guidance information for the delicate clothing to be placed into a second clothing treatment appliance from among a plurality of clothing treatments appliances, when there is no user agreement on operation after the guidance information is outputted by one of the clothing treatment appliances, wherein the second clothing treatment appliance is capable of treating the delicate clothing.

13. The clothing treatment method according to claim 10, further comprising:
registering the clothing information and each recommended course according to the clothing information.

14. The clothing treatment method according to claim 13, wherein the registering comprises:
obtaining an image of a label and fabric construction for the clothing;
comparing the obtained image with previously registered clothing information; and
generating new clothing information when the image does not match the previously registered clothing information.

15. A clothing treatment apparatus, comprising:
a clothing treatment appliance configured to perform at least one of washing, drying, sterilizing, deodorizing, dust removing, or wrinkle removing for clothing;
a first device configured to identify clothing information for each piece of the clothing located in the clothing treatment appliance;
a second device configured to identify a course that is associated with the clothing information identified by the identifying unit; and
a third device configured to control operation of the clothing treatment appliance according to the identified course.
